(19) United States
(12) Patent Application Publication
(10) Pub. No.: US 2010/0235245 A1
(43) Pub. Date: Sep. 16, 2010

(54) PHILANTHROPIC ADVERTISING CAMPAIGNS

(75) Inventors: David Allen Grossman, Redmond, WA (US); Robert Joseph Devine, Kirkland, WA (US); Enrique De La Garza, Kirkland, WA (US); Hrishikesh Bal, Bellevue, WA (US); Travis Muhlestein, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/403,663

(22) Filed: Mar. 13, 2009

(51) Int. Cl. G06Q 30/00

(52) U.S. Cl. 705/14.73

(57) ABSTRACT

Methods, systems, and computer-readable media for directing funds to philanthropic organizations are provided. An advertisement server system includes advertisement servers, databases, and client devices. Publishers register with advertisement servers to select philanthropic organizations and to customize advertisement placeholders that are rendered on sites web pages associated with the publishers. The databases store records and accounts for the publishers and philanthropic organizations. The client devices interact with the web pages associated with the publishers. And based on the level of interaction by the client devices with an advertisement placeholder, the philanthropic organization that is linked to the advertisement placeholder is directly provided with a financial donation from the advertisement server system listing the publisher as a donor.

### BACKGROUND

Conventionally, charities receive donations from entities that send gifts to the charities. The gifts typically include time, cash, checks, or products. For instance, when an entity generates revenue, the entity may decide to contribute some portion of the generated revenue to a charity. However, because the entity must remember to donate the funds after generating revenue it is likely the charity may lose gifts because the entity neglects to send the gift to the charity.

Currently, an entity that has advertising space for sale may generate revenue by allowing advertisers to display advertisements in the advertising space. On the Internet, these entities are publishers who have web pages that provide web page real estate for advertisers to display the advertisements to potential consumers of the goods or services. The publishers earn revenue in proportion to clicks on the advertisements by potential consumers. Conventionally, the publisher may donate a portion of the revenue earned by sending a check to the charity. If a publisher hopes to donate all their revenue from a specific web site, the publisher will have to remember to send the donation every month.

Conventionally, publishers rely on the charities to keep accurate records that acknowledge each separate donation. These onerous burdens on the publishers and charities may increase the likelihood that publishers chose to forego support of worthy charity.

### SUMMARY

Embodiments of the invention overcoming these and other problems in the art relate in one regard to an advertisement server system, computer-readable media, and computer-implemented method to direct funds from publishers to philanthropic organizations. The advertisement server system allows publishers to direct funds from normal publishing activities to philanthropic organizations. This may increase the likelihood that publishers will donate to the philanthropic organizations.

The advertisement server system includes advertisement servers and databases. The advertisement servers are configured to register a publisher having web page real estate available for advertising. The databases are connected to the advertisement servers. The databases are configured to store records of each philanthropic organization selected by the publisher. In turn, the advertisement servers provide a management graphical user interface for customizing an advertisement placeholder transmitted to the publisher. In some embodiments, the advertisements rendered in the advertisement placeholder are filtered by the advertisement server to be consistent with a selected philanthropic organization that corresponds to the advertisement placeholder.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 is a network diagram that illustrates an exemplary computing system in accordance with embodiments of the invention;

FIG. 2 is a graphical user interface that illustrates an exemplary authentication page in accordance with embodiments of the invention;

FIG. 3 is a graphical user interface that illustrates another exemplary authentication page in accordance with embodiments of the invention;

FIG. 4 is a graphical user interface that illustrates an exemplary registration page in accordance with embodiments of the invention;

FIG. 5 is a graphical user interface that illustrates an exemplary verification page in accordance with embodiments of the invention;

FIG. 6 is a graphical user interface that illustrates exemplary controls in accordance with embodiments of the invention;

FIG. 7 is a graphical user interface that illustrates an exemplary configuration page in accordance with embodiments of the invention;

FIG. 8 is a graphical user interface that illustrates another exemplary configuration page in accordance with embodiments of the invention;

FIG. 9 is a graphical user interface that illustrates an exemplary advertisement placeholder creation page in accordance with embodiments of the invention;

FIG. 10 is a graphical user interface that illustrates exemplary advertisement placeholders in accordance with embodiments of the invention;

FIG. 11 is a graphical user interface that illustrates an exemplary report generation page in accordance with embodiments of the invention;

FIG. 12 is a logic diagram that illustrates an exemplary computer-implemented method for directing funds to a philanthropic organization in accordance with embodiments of the invention;

FIG. 13 is a logic diagram that illustrates an exemplary computer-implemented method for transmitting advertisements to registered publishers in accordance with embodiments of the invention; and

FIG. 14 is a logic diagram that illustrates an exemplary computer-implemented method for generating donation reports for registered publishers in accordance with embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, or firmware. Also, as utilized herein, the term “publisher” refers to at least one computer hosting web pages that receive advertisement placeholders and advertisements that are displayed in the advertisement placeholders.

Embodiments of the invention provide an advertisement server system that allows publishers to direct advertising revenue to designated philanthropic organizations. The advertisement server system improves the visibility of an advertiser's goods or services, increases inventory of publisher web page real estate, and increases advertiser bid density. The advertisement server system provides graphical user interfaces to select a philanthropic organization that directly receives a portion of the revenue generated by the publisher. The advertisement server system identifies each publisher that donates to a philanthropic organization as a donor. The publishers receive advertisement placeholders corresponding to a philanthropic organization selected by the publisher. In an embodiment, the advertisement server system searches an account database to provide a report generation page that reports the donations made by each publisher to each philanthropic organization over a selected period of time.

During registration with the advertisement server system, a publisher creates an account, specifies whether an employer provides matching contributions, and identifies one or more accounts to receive revenue earned by the publisher. The advertisement server system tracks the number of clicks on an advertisement displayed in the advertisement placeholder. In turn, revenue is directed to the account established by the publisher based on the number of clicks. In some embodiments, at least one account belongs to a philanthropic organization, and the advertisement management system directs a portion of the revenue to the account dedicated to the philanthropic organization.

Accordingly, the advertisement server system creates a philanthropic advertising campaign using advertisement placeholders displayed on web pages belonging to publishers. The advertisement placeholders identify a philanthropic organization supported by the publisher and shows advertisements received from the advertisement server system in the advertisement placeholder. The advertisement server system directs revenue to the philanthropic organization supported by the publisher on a monthly basis and does not direct this revenue to the publisher. In some embodiments, the advertisement server system generates an Internal Revenue Service (IRS) 1099 earnings statement for the philanthropic organization supported by the publisher. Also, the advertisement server system generates a charitable donation tax receipt at the end of each year for the publisher.

A computer system for directing revenue generated from advertisements includes client devices communicatively connected to a publisher, e.g., web pages, blogs, wikis, or intranet pages. The users of the client devices interact with the content on the web pages and click on advertisements associated with the publisher. The publisher generates revenue based on the level of interaction with the advertisements, and philanthropic organizations may receive a portion of the revenue as a gift from the publisher.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

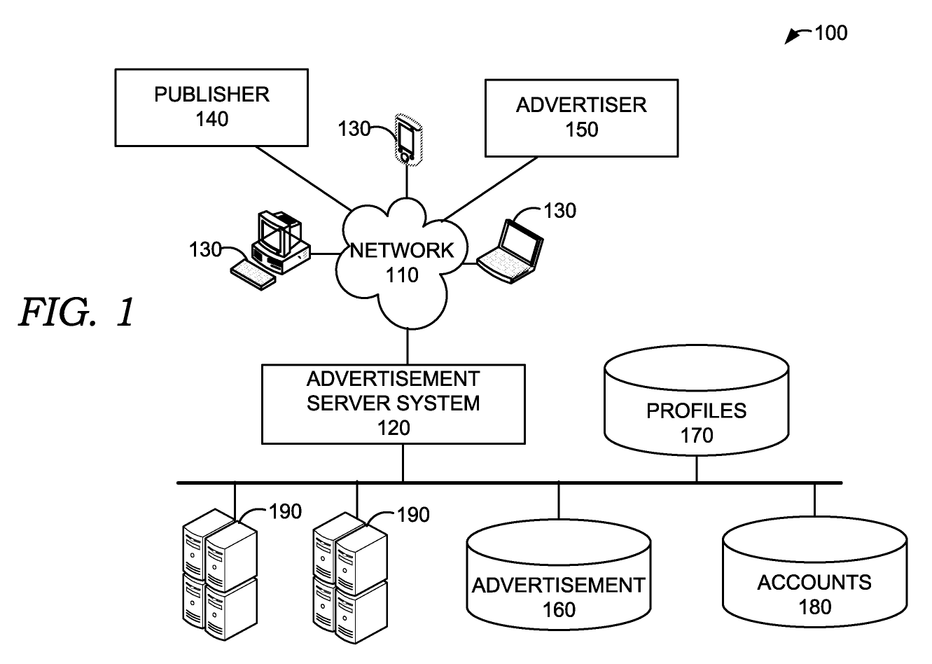

FIG. 1 is a network diagram that illustrates an exemplary computing system in accordance with embodiments of the invention. The computing system 100 includes a network 110, an advertisement server system 120, client devices 130, a publisher 140, an advertiser 150, an advertisement database 160, profiles database 170, accounts database 180, and advertisement servers 190.

The network 110 is configured to facilitate communication between the client devices 130 and the publisher 140. The network 110 also facilitates communication between the advertisement server system 120, the advertiser 150, the publisher 140, and the advertisement servers 190. The network 110 may be a communication network, such as a wireless network, local area network, wired network, or the Internet. In an embodiment, the client devices 130 interact with the publisher 140 utilizing the network 110. In response, the publisher 140 provides web pages that include advertisements, where a subset of the advertisements correspond to philanthropic organizations.

The advertisement server system 120 generates advertisement placeholders and selects advertisements that are transmitted via network 110 to the publisher 140. In turn, the publisher 140 includes the advertisement placeholder on a web page and displays the advertisement in the advertisement placeholder. The publisher 140 transmits the web page to client devices 130, which display the advertisements to the user.

In certain embodiments, the advertisement server system 120 interfaces with the publisher 140 to transmit the advertisements. The advertisement server system 120 may require the publisher 140 to configure the advertisement placeholder by specifying a size, a shape, a color, or advertisement filtering criteria. The filtering criteria prevents unwanted advertisements from being displayed in the advertisement placeholder. For instance, the filtering criteria may remove advertisements having specified terms, a specified size, a specified media format, etc.

The advertisement server system 120 also interfaces with the advertisers 150 to allow the advertisers 150 to submit advertisements to the advertisement server system 120. The advertisers 150 provide the advertisement server system 120 with keywords, targeting data, and bids that correspond to the publisher's content or a philanthropic organization that linked to a advertisement placeholder on the web page generated by the publisher. The advertisement server system 120 processes the information provided by the publishers 140 and advertisers 150 and selects a set of appropriate advertisements to transmit to the publisher 140 for display in the advertisement placeholder.

The client devices 130 are utilized by a user to generate search terms and to receive web pages that are relevant to the search terms. The client devices 130 also receive web pages request by the user. The web pages may include advertisements. The client devices 130 include, without limitation, personal digital assistants, smart phones, laptops, personal computers, gaming systems, set-top boxes, or any other suitable client computing device. In one embodiment, the client devices 130 are advertisement-funded client devices that are configured to display advertisements as part of the graphical user interface provided by the operating system of the client devices 130. The client devices 130 include user and system information storage to store user and system information on the client devices 130. The user information may include search histories, cookies, and passwords. The system information may include internet protocol addresses, cached Web pages, and system utilization. In some embodiments, the client devices 130 transmit click requests for one or more advertisements to the publisher 140. In turn, the publisher 140 tracks the click requests for the advertisements displayed in the advertisement placeholder and transmits the number of click requests to the advertisement server system 120.

The publisher 140 stores web pages having web page real estate available to display an advertisement placeholder and advertisements. In some embodiments, the advertisement placeholder corresponds to a philanthropic organization. The publisher 140 tracks the click requests—received from the client devices 130—for the advertisement placeholder or advertisements. The publisher 140 receives revenue based on the number of click requests received by the advertisement or advertisement placeholder. The publisher 140 is communicatively connected to the advertisement server system 120. The publisher 140 receives advertisements from the advertisement server system 120. The publisher 140 returns, to the client devices 130, the advertisements received from the advertisement server system 120. In some embodiments, the publisher 140 configures the advertisement placeholder and creates a content filter that discards certain advertisements received from the advertisement server system 120.

The advertiser 150 provides targeting data, keywords, bids for keywords, bids for targeting data, and advertisements to the advertisement management system 120. The advertiser 150 promotes goods or services with the advertisements. In some embodiments, the advertiser 150 may opt-in to target philanthropic organizations that are registered with the advertisement server system 120. The targeting of philanthropic organizations may allow the advertiser 150 to reach additional populations of potential consumers and additional web pages with web page real estate available to display advertisements.

The advertisement database 160 stores advertisements. The advertisement database 160 is created based on the advertisements received from the advertiser 150. In an embodiment, the advertisement database 160 is a relational database or an object-oriented database. The advertisement database 160 also stores the keywords, targeting data, and bids associated with each advertisement. In some embodiments, the advertisements are banner advertisements, display advertisements, text, images, contextual advertisements, search advertisements, audio advertisements, or mobile advertisements that describe a good, service or thing that an advertiser wishes to promote to users. The things described in the advertisements may include events and items from all over the world, from various merchants, and from various distributors. The advertisements are selected by the advertisement server system 120 and transmitted to the publishers 140.

The profiles database 170 stores publisher data. The publishers 140 provide the advertisement server system 120 with authentication data, web page locations, and advertisement placeholder configuration data for storage in the profile database 170. In an embodiment, the profiles database 170 is a relational database or an object-oriented database. The authentication data includes a user name or password selected by the publisher 140. The authentication data is used to prevent unauthorized access to the data store in the profiles database. The web page locations are the addresses of the web pages on which an advertisement placeholder is displayed. The advertisement placeholder configuration data includes the color and filter criteria for each advertisement placeholder associated with a web page specified by the publisher 140. In some embodiments, the profiles database 170 stores charity data that indicates whether a publisher 140 chose to donate a portion of the revenue received from advertising to a philanthropic organization. The profile database 170 is accessed to authenticate a publisher that wishes to update any profile data stored in the profile database 170. In some embodiments, the content of the profile database 170 is encrypted with a private key algorithm or a public key algorithm. For instance the algorithm may be a Diffie-Hellman algorithm, blowfish algorithm, or a version of the data encryption standard algorithm.

The accounts database 180 stores the funds received from advertisers based on the clicks on the advertisements rendered in the advertisement placeholder displayed on web page real estate made available by the publisher 140. The accounts are associated with a publisher 140. In an embodiment, the accounts database 180 is a relational database or an object-oriented database. A publisher 140 may have at least one account in the accounts database 180 that is dedicated to storing revenue generated by the publisher 140. The publisher 140 may have additional accounts dedicated to revenue generated for philanthropic organizations. In some embodiments, the revenue in accounts dedicated to philanthropic organizations is matched by a company that has a gift matching campaign. The publisher 140 may be operated by an employee of the company. Thus, the accounts database 180 may be connected with any company selected by the publisher 140 if the company directs funds into the accounts dedicated to philanthropic organizations to match the funds designated for charitable donations by the publisher 140. Because the accounts are associated with a publisher 140 and a philanthropic organization, the publisher 140 may search the accounts database 180 to determine the number and size of each donation made to each philanthropic organization having an account in the accounts database 180.

The advertising servers 190 provide application programming interfaces to allow the advertisement server system 120, publisher 140, and advertiser 150 to communicate with the advertisement database 160, profile database 170, and accounts database 180. The advertising servers 190 also provide graphical user interfaces to the advertisement server system 120 to, among other things, register publishers 140, to customize advertisement placeholders, and to report the donations received for a specified philanthropic organization over a period of time. In an embodiment, the advertising servers 190 ensure that the proper advertisements are delivered to the publisher 140 based on the publisher profile data and the advertiser targeting data.

Accordingly, the computing system 100 is configured with a publisher 140 that provides advertisements to a client device 130 based on targeting data and advertisement placeholder customizations stored by the advertisement server system 120. The advertisement server system 120 traverses the advertisement database 160 to provide advertisements to the publisher 140. In turn, the advertisement server system 120 generates revenue for the publisher 140 based on click requests received from the client device 130.

In one embodiment, a log-in graphical user interface is presented to a publisher. The log-in graphical user interface prevents unauthorized access to the advertisement server system. After the publisher provides the correct credentials, the publisher may choose to update a profile, check on revenue generated by the publisher, or request receipts to report revenue and donations made to philanthropic organizations.

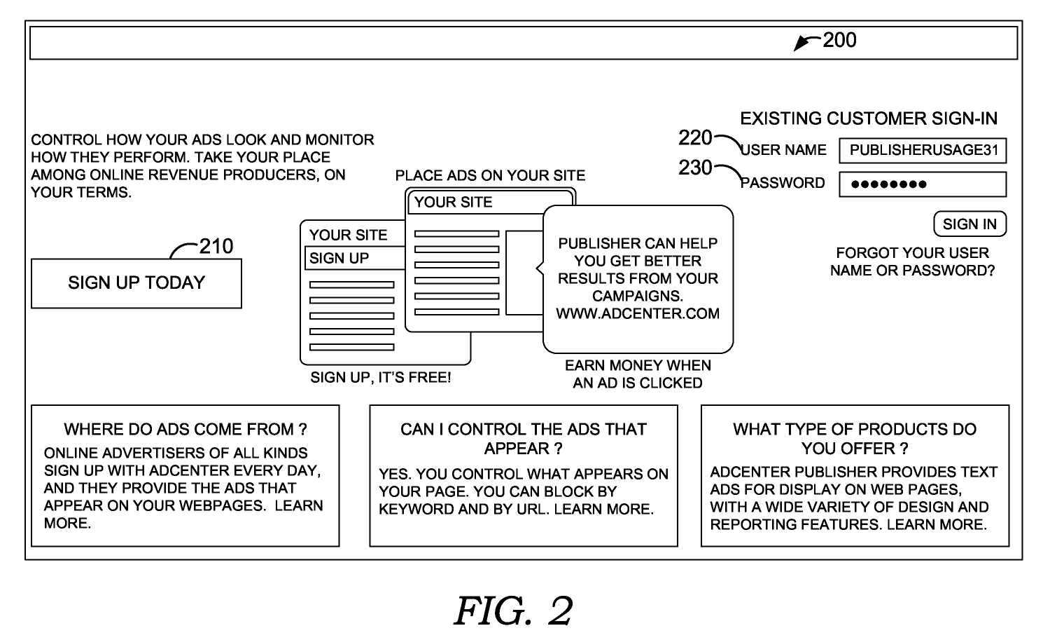

FIG. 2 is a graphical user interface 200 that illustrates an exemplary authentication page in accordance with embodiments of the invention. The graphical user interface 200 has a sign-up link 210 for new publishers to register with the advertisement server system. The graphical user interface 600 also includes a user name field 220 and a password field 230. A publisher of the advertisement server system may log-in using credentials established during registration with the advertisement server system. The publisher enters the user name in the user name field 220 and the password in the password field 230. The advertisement server system checks the profile database to authenticate the user. If incorrect credentials are provided in the user name field 220 or the password field 230, the advertisement server system may allow the publisher additional attempts. After a number of unsuccessful attempts, the advertisement server system may lock the account and prevent additional attempts. In some embodiments, the number of unsuccessful attempts is 3.

In another embodiment, a log-in graphical user interface is presented to a publisher. The log-in graphical user interface allows publishers without designated philanthropic organizations to register for accounts dedicated to philanthropic organizations. After registering for a philanthropic organization, on the next log-in the publisher is not be prompted to designate a philanthropic organization.

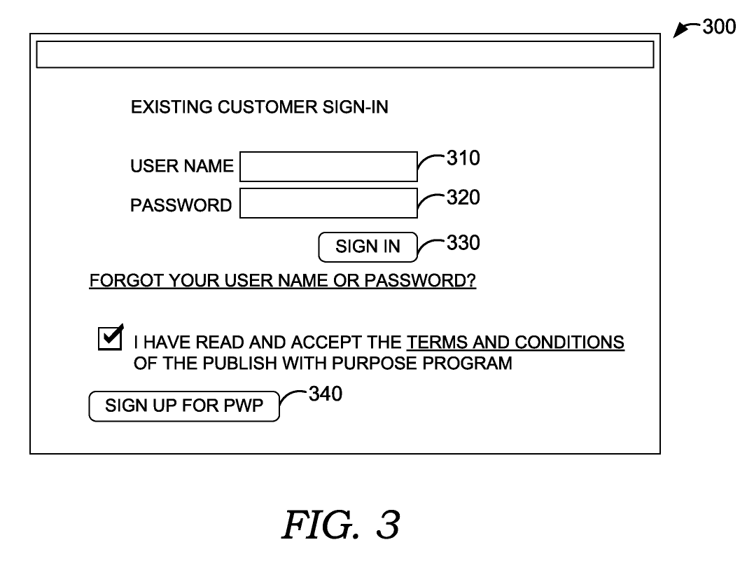

FIG. 3 is a graphical user interface 300 that illustrates another exemplary authentication page in accordance with embodiments of the invention. The graphical user interface 300 has a sign-up link 340 for publishers to create an account that is dedicated to a philanthropic organization. The sign-up link 340 is only displayed to existing publishers that have not created an account that is dedicated to a philanthropic organization. The graphical user interface also includes a user name field 310, a password field 320, and a sign-in link 330. A publisher of the advertisement server system may log-in using credentials established during registration with the advertisement server system by entering the user name in the user name field 310 and the password in the password field 320 and selecting the sign-in link 330. The advertisement server system authenticates the publisher based on data stored in the profile database. After a number of unsuccessful attempts, the advertisement server system may lock the account and prevent additional attempts. In some embodiments, the number of unsuccessful attempts is 3.

In certain embodiments, a registration graphical user interface is presented to a publisher. The registration graphical user interface provides publishers with controls to create a new account. The publisher identifies the account as a standard account or an account dedicated to the philanthropic organization. In turn, the publisher provides identifying information and if necessary selects a philanthropic organization when the publisher chooses to dedicate revenue to a philanthropic organization.

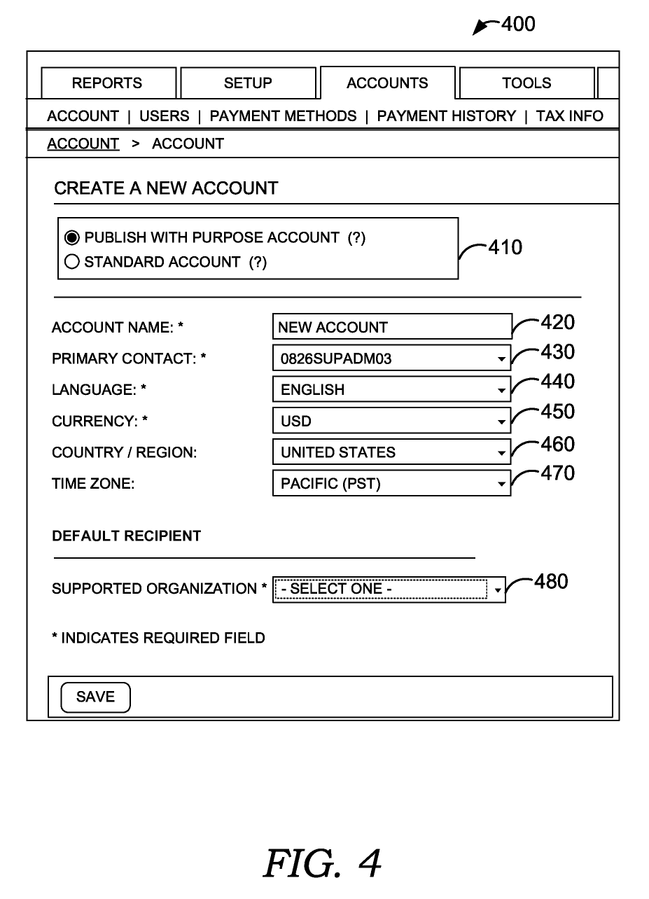

FIG. 4 is a graphical user interface that illustrates an exemplary registration page in accordance with embodiments of the invention. The registration graphical user interface 400 includes an account type control 410, account name field 420, contact field 430, language field 440, currency field 450, country field 460, time zone field 470, and philanthropic organization field 480. The registration graphical user interface 400 is provided to a new publisher or a publisher that is requesting additional accounts. The account type control 410 allows the publisher to specify whether the new account is a standard account or a philanthropic account. The account name field 420 allows the publisher to enter a name of the account that is being created by the publisher. The contact field 430 allows the publisher to enter an electronic mail alias or electronic messaging alias for the publisher. The language field 440 allows the publisher to enter the language in which the content of web pages are published by the publisher. In some embodiments, the language includes English, Spanish, French, Portuguese, or Pinyin. The currency field 450 allows the publisher to enter the monetary notes traded by the publisher. The country field 460 allows the publisher to enter the location of the computer that stores the web pages that are published by the publisher. The time zone field 470 allows the publisher to enter the time zone of the computer that stores the web pages that are published by the publisher. The philanthropic organization field 480 allows the publisher to enter a philanthropic organization that is selected to receive a portion of the revenue generated by the publisher. The advertisement server system receives an stores the data entered in the account type control 410, account name field 420, contact field 430, language field 440, currency field 450, country field 460, time zone field 470, and philanthropic organization field 480. The data is stored in the accounts database by the advertisement server system.

In some embodiments, a verification graphical user interface is presented to a publisher. The verification graphical user interface provides publishers with controls to verify the publisher's identity. The publisher verifies the alias, tax identifier, and account type. In turn, the publisher customizes the advertisement placeholder to correspond with a philanthropic organization selected by the publisher.

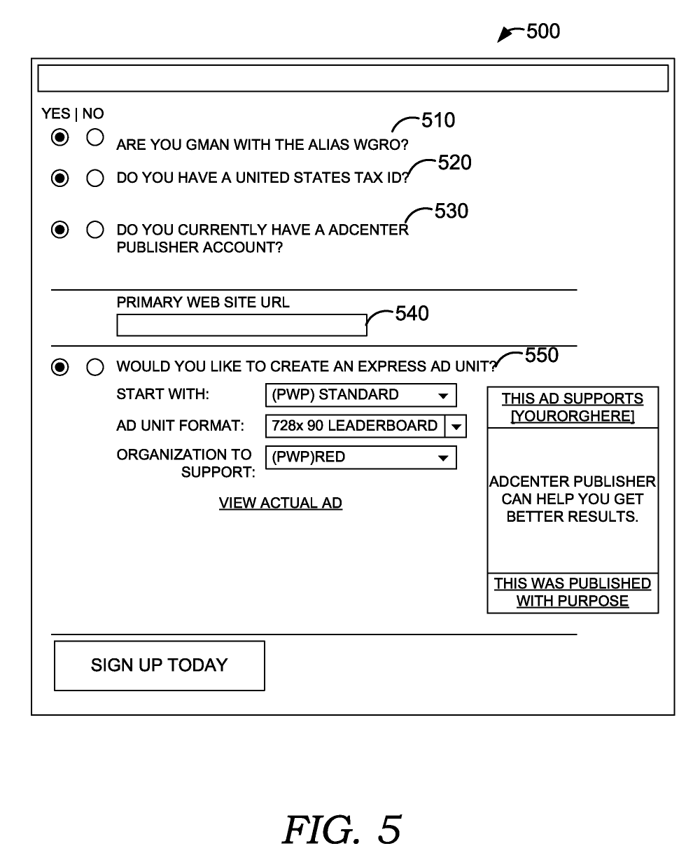

FIG. 5 is a graphical user interface that illustrates an exemplary verification page in accordance with embodiments of the invention. The verification graphical user interface 500 includes user name control 510, a tax identifier control 520, a philanthropic organization control 530, a web page field 540, and an advertisement placeholder control 550. The advertisement server system verifies the data entered in the user name control 510, tax identifier control 520, philanthropic organization control 530, web page field 540 with the data stored in the profiles database or accounts database. In other embodiments, the advertisement server system may also update the data stored in the accounts database or profiles database with data entered in the user name control 510, the tax identifier control 520, the philanthropic organization control 530, the web page field 540, and the advertisement placeholder control 550. The verification graphical user interface 500 is provided to an existing publisher that is requesting to dedicate additional accounts to a philanthropic organization. The user name control 510 allows the publisher to verify that the alias is correct and is associated with the publisher. The tax identifier control 520 allows the publisher to verify that the publisher has a tax identifier. The philanthropic organization control 530 allows the publisher to verify that the publisher has a philanthropic organization account. The web page field 540 allows the publisher to enter an address or uniform resource locator (URL) for a web page that is to receive the advertisements and advertisement placeholder. The advertisement placeholder control 550 allows the publisher to create an advertisement placeholder. Additionally, the publishers may configure the size and format of the advertisement placeholder that is delivered to the web page identified by the publisher via the advertisement placeholder control 550.

In some embodiments, the controls provided to the publisher enables the publisher to select philanthropic organizations, advertisement placeholder placement, and the color of the advertisement placeholder. The advertisement server system receives the selections of the philanthropic organizations, selections of the placement and size of the advertisement placeholder, and selection of the color of the advertisement placeholder. In turn, the advertisement server system generates an advertisement placeholder based on the selections received from the publishers.

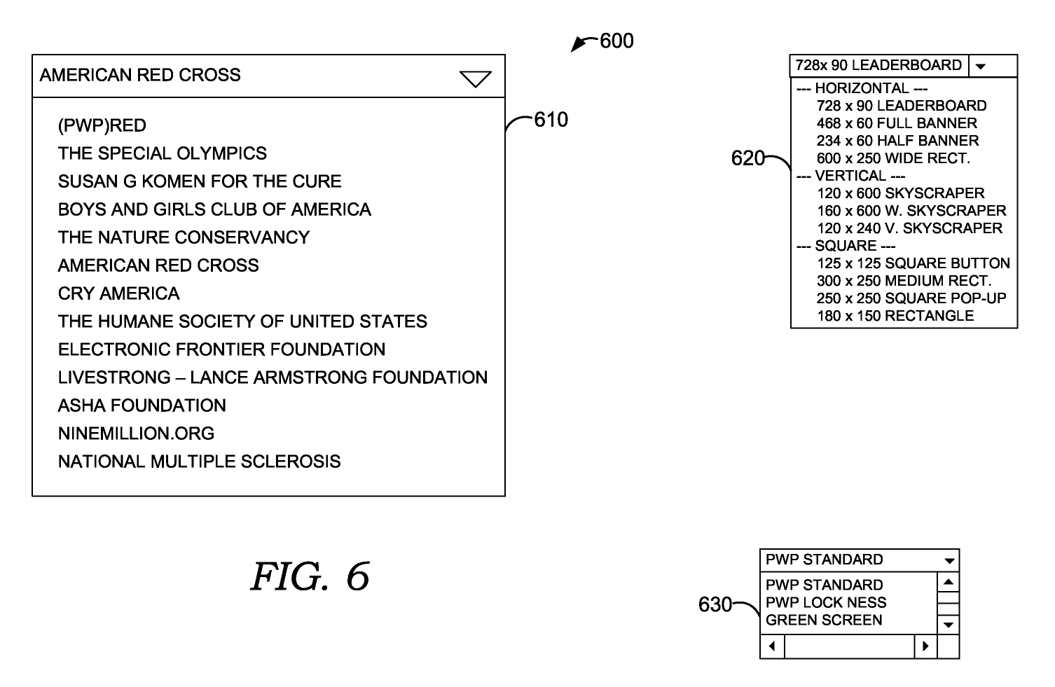

FIG. 6 is a graphical user interface that illustrates exemplary controls in accordance with embodiments of the invention. The controls 600 include a philanthropic organization control 610, advertisement placeholder placement control 620, and color control 630. In some embodiments, the philanthropic organization control 610 may operate as a drop-down box to reveal philanthropic organizations that are registered with the advertisement server system. The publisher may select any of the philanthropic organizations in the drop-down box. The advertisement placeholder placement control 620 may operate as a drop-down box to show preconfigured advertisements placeholders having various sizes and shapes that the publisher may select. The color control 630 may also operate as a drop-down box that allows the publisher to select colors for the selected advertisements placeholders.

In other embodiments, a configuration graphical user interface is presented to a publisher. The configuration graphical user interface provides publishers with controls to customize the advertisement placeholders. The configuration graphical user interface also include a help pane to explain customization of the advertisement placeholders. In turn, the publisher may specify whether the philanthropic organization associated with the advertisement placeholder receives all or a portion of the revenue generated by the advertisements in the advertisement placeholder.

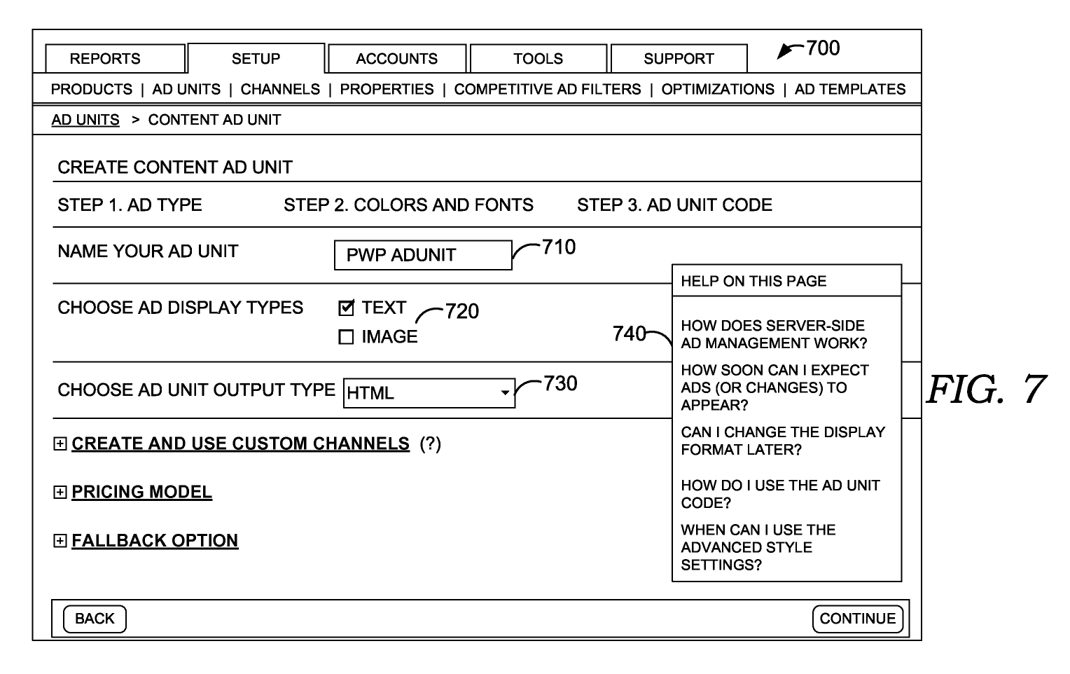

FIG. 7 is a graphical user interface that illustrates an exemplary configuration page in accordance with embodiments of the invention. The configuration graphical user interface 700 includes a name placeholder field 710, a media format control 720, a markup language control 730, and help pane 740. The advertisement server system may store data entered in the name placeholder field 710, the media format control 720, the markup language control 730 in the accounts database or profiles database. In an embodiment, the information displayed in the help pane 740 may be received from the advertisement database. The name placeholder field 710 allows the advertisement server system to receive a name for the advertisement placeholder from the publisher. The name received from the publisher may be used to access the advertisement placeholder. The media format control 720 allows the advertisement server system to receive a media format specified by the publisher. The media format may indicate a format for the advertisements that are displayed in the advertisement placeholder. In one embodiment, the advertisements may be any combination of text, image, audio, or video. The markup language control 730 allows the advertisement server system to receive an output language specified by the publisher. The output language may indicate a language for the advertisement placeholder that is sent to the publisher. In an embodiment, the output language may include hypertext markup language (HTML), extensible markup language (XML), Perl, Java, or C. The help pane 740 is updated to provide information about using controls that the publisher is interacting with on the configuration graphical user interface 700.

In some embodiments, an additional configuration graphical user interface is presented to a publisher. The configuration graphical user interface provides publishers with detail controls to further customize the advertisement placeholders. The configuration graphical user interface also includes a help pane to explain customization of the advertisement placeholders. In turn, the advertisement server system may generate a preview of the advertisement placeholder using the configurations provided by the publisher.

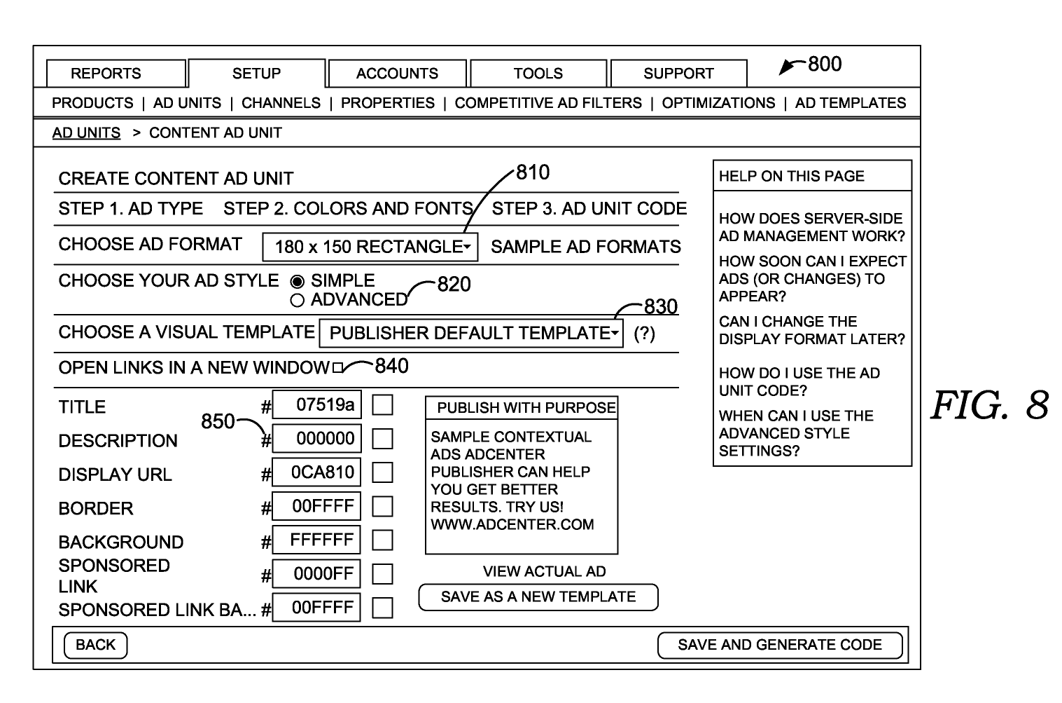

FIG. 8 is a graphical user interface that illustrates another exemplary configuration page in accordance with embodiments of the invention. The additional configuration graphical user interface 800 includes a placement control 810, a style control 820, a template control 830, a window management control 840, and color controls 850. The advertisement server system may store data entered in the placement control 810, the style control 820, the template control 830, the window management control 840, and the color controls 8500 in the accounts database, advertisement database, or profiles database. The placement control 810 allows the advertisement server system to receive a size, shape, and placement for the advertisement placeholder from the publisher. The placement received from the publisher may be used to position the advertisement placeholder on a web page specified the publisher. The style control 820 allows the advertisement server system to receive complexity for the advertisement placeholder from the publisher. The complexity received from the publisher may be used to determine the number of visual effects or the type of font to use when displaying the advertisement in the advertisement placeholder. In some embodiments, the complexity may range from simple to advanced. The template control 830 allows the advertisement server system to receive a layout for the advertisement placeholder from the publisher. The layout received from the publisher may be used to determine the number of advertisements to include in the advertisement placeholder, the location of the advertisements in the advertisement placeholder, and filtering criteria that limits advertisements that are selected for display in the advertisement placeholder based on, among other things, the content of the advertisement. The window management control 840 allows the advertisement server system to set a flag to allow the advertisement displayed in the advertisement placeholder and selected by the user to open in a separate window. The separate window is used to transition from the webpage having the advertisements and advertisement placeholder to a separate window having content corresponding to the selected advertisement. The color controls 850 allows the advertisement server system to set colors for the text and links that are included in the advertisements and in the advertisement placeholder. In some embodiments, the colors are selected by the publisher and are used to render the advertisements and advertisement placeholder.

In an embodiment, an advertisement placeholder creation graphical user interface is presented to a publisher. The advertisement placeholder creation graphical user interface provides publishers with code that is generated by the advertisement server system. The code is used to create the advertisement placeholder using the customizations received from the publisher. In turn, the publisher places the code on the web page to render the advertisement placeholder and to receive advertisements from the advertisement server system.

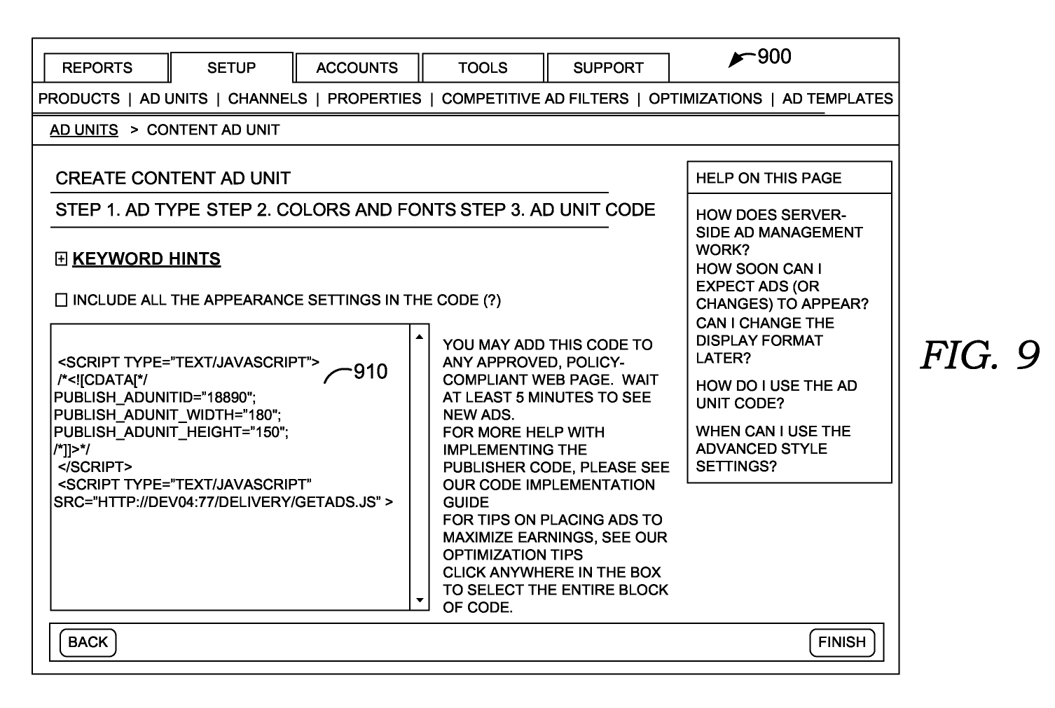

FIG. 9 is a graphical user interface that illustrates an exemplary advertisement placeholder creation page in accordance with embodiments of the invention. The advertisement placeholder creation graphical user interface 900 includes a code control 910. The code control 910 allows the advertisement server system to dynamically generate the programming code for the advertisement placeholder customized by the publisher based on the information stored in the advertisement database, profile database, and account database. The generated programming code is displayed to the publisher who places the code on a publisher's web page having web page real estate available for advertisement placeholders.

In some embodiments, the advertisement placeholder is rendered on a web page belonging to the publisher. The advertisement placeholder may include a link to the philanthropic organization selected by the publisher and associated with the advertisement placement placeholder. Depending on the complexity of the advertisement placeholder, the advertisement server system may transmit video, audio, or other media advertisements to the advertisement placeholder. The web page displays the advertisement placeholder may receive and render the video, audio, or other media advertisements.

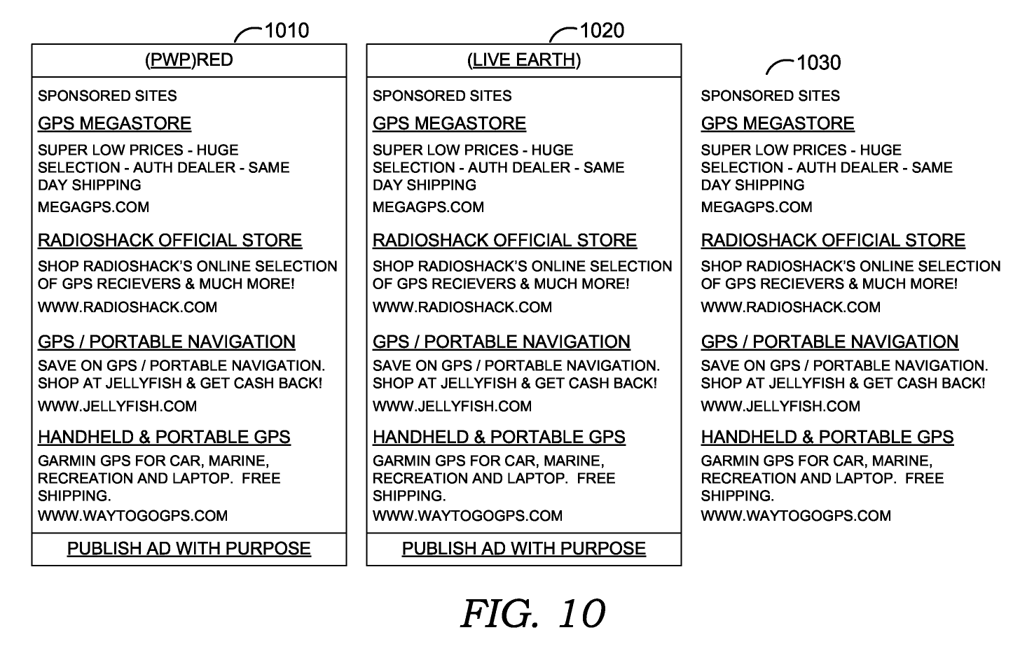

FIG. 10 is a graphical user interface that illustrates exemplary advertisement placeholders in accordance with embodiments of the invention. The advertisement placeholders 1010, 1020, and 1030 are rendered on a web page identified by the publisher. The advertisement placeholders range in complexity with 1010 and 1020 having advanced complexity and 1030 having simple complexity. The advertisement server system uses that data stored in the advertisement database, accounts database or profiles database to generate an appropriate advertisement placeholder 1010, 1020, 1030. The advertisement placeholders 1010, 1020, and 1030 may include a tagline to indicate that the publisher is supporting a philanthropic organization. The tagline may be stored in the advertisement database and may link to a registration graphical user interface that is provided by the advertisement server system. In certain embodiments, the tagline is a support tag. The support tag includes the name and URL of the philanthropic organization. The support tag may provide the philanthropic organization with free impressions and potential revenue. The placement of the tagline in the advertisement placeholder 1010, 1020, and 1030 differs based on the style selected by the publisher.

In an embodiment, a report generation graphical user interface is presented to a publisher or an entity identified as a matching partner. The report generation graphical user interface provides publishers or a matching partner with reports about the donations and clicks received by advertisement placeholders rendered by the publisher. The reports may be used by the matching partner to match the gifts donated by the publisher. The reports may also be used to report gifts made to philanthropic organizations during a specified time period. In some embodiments, the reports may display performance metrics, such as, dwell time, web page history showing changes to the web page over a period of time, advertisement update frequency, and advertisement filtering data.

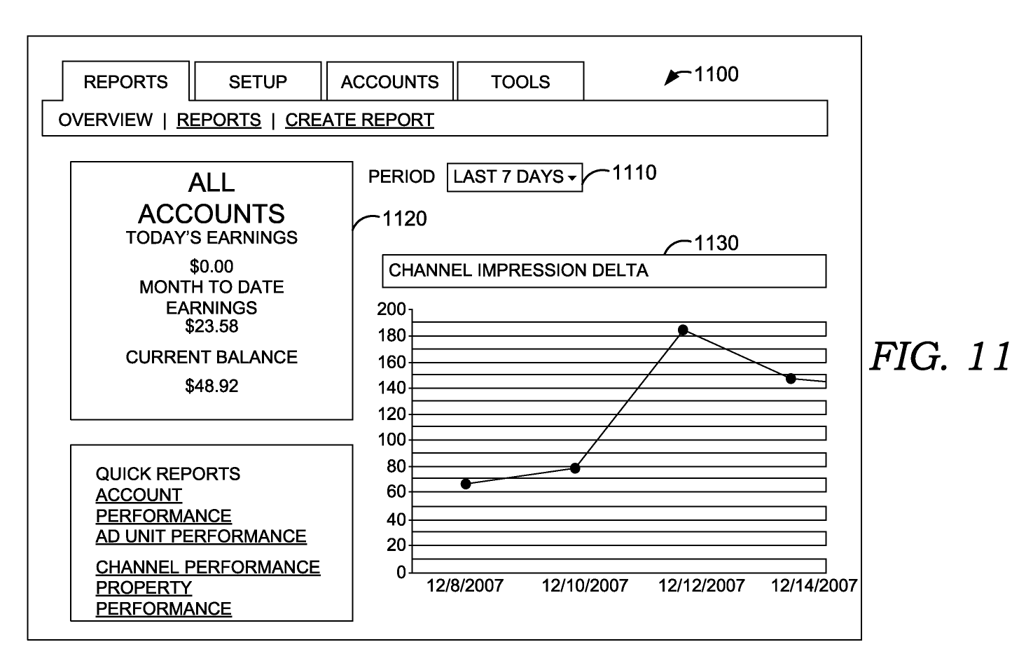

FIG. 11 is a graphical user interface that illustrates an exemplary report generation page in accordance with embodiments of the invention. The report generation graphical user interface 1100 includes a period control 1110, a revenue control 1120, and a graph control 1130. The advertisement server system searches that data stored in the advertisement database, accounts database or profiles database to generate a requested report. The period control 1110 allows the advertisement server system to receive a time period of interest. The time period of interest is selected by the publisher or matching partner to determine the revenue generated by the advertisement placeholder. In an embodiment, the time period may be weekly, monthly, quarterly, or yearly. The advertisement server system traverses the accounts linked to the advertisement placeholder to access the revenue data. The revenue control 1120 allows the advertisement server system to display the revenue generated over the time period of interest. The revenue displayed includes a daily revenue, a monthly revenue, and a current statement of the revenue remaining in the account corresponding to the advertisement placeholder. The graph control 1130 allows the advertisement server system to display the number of impressions the advertisements in the advertisement placeholder received over the time period of interest. The number of impressions and number clicks may be used to determine the revenue dedicated to the philanthropic organization associated with the advertisement placeholder.

In an embodiment, the advertisement server system is configured to execute logic for directing revenue to a philanthropic organization identified by a publisher. The advertisement server system may determine a number of impressions and a number clicks. In turn, revenue is transmitted to the philanthropic organization by the advertisement server system based on a ratio selected by the publisher.

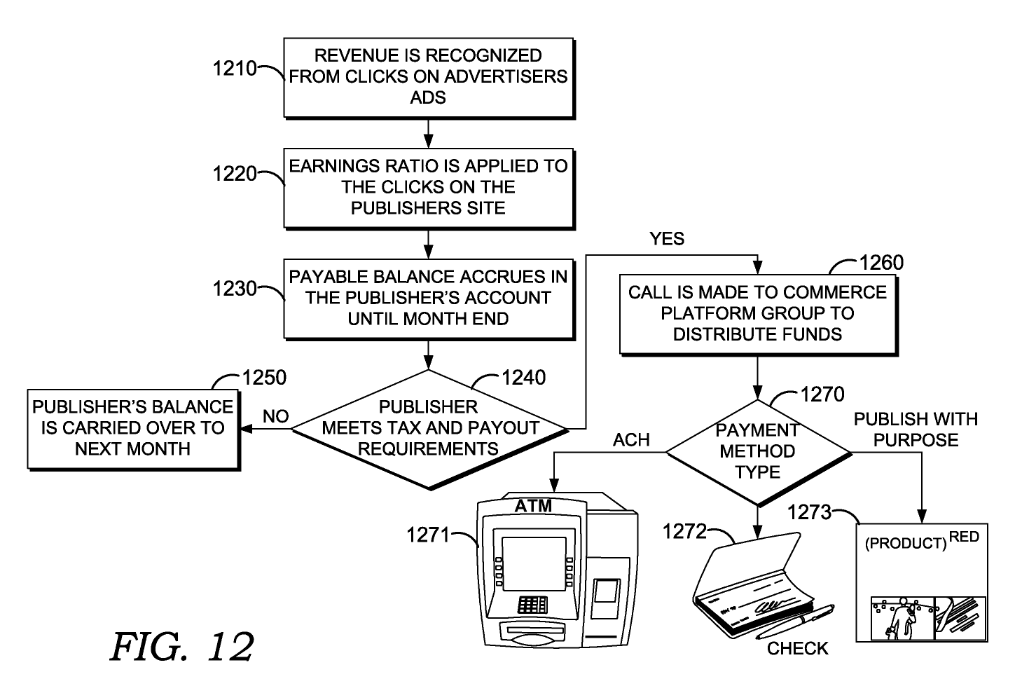

FIG. 12 is a logic diagram that illustrates an exemplary computer-implemented method for directing funds to a philanthropic organization in accordance with embodiments of the invention. In step 1210, the advertisement server system recognizes revenue from bids placed by an advertiser and in proportion to clicks on advertiser's advertisements. In turn, the advertisement server system determines an earnings ratio selected by the publisher, in step 1220. The earnings ratio is used to calculate a donation to a philanthropic organization. In step 1230, the balance accrues in the standard account or the philanthropic account that corresponds to the publisher. In step 1240, the philanthropic account is checked to determine if revenue in the accounts meet appropriate thresholds. If the thresholds are not satisfied, the funds stay in the philanthropic account in step 1250. If the thresholds are satisfied, the funds are distributed by a commerce platform of the advertisement server system in step 1260. In step 1270, the advertisement server determines the payment method selected by the publisher. The payment methods include, automated teller machines (ATM), checks, or direct deposits. If the publisher selects ATM as the payment method, the philanthropic organization may obtain the gift at the ATM in step 1271. If the publisher selects checks as the payment method, the philanthropic organization may obtain the gift via a check that is posted to the philanthropic organization in step 1272. If the publisher selects direct deposit as the payment method, the philanthropic organization may obtain the gift directly deposited in a bank account in step 1273. In some embodiments, funds may be distributed to any combinations of the following: check, ATM, and direct deposit into a bank account for the philanthropic organization. Payment redirection from publishers to philanthropic organizations allow 100% pass through of revenue generated by the publisher.

In certain embodiments, a publisher registers with the advertising server system. The advertisement server system identifies a philanthropic organization selected by the publisher. The advertisement server system also generates an advertisement placeholder for the advertisements. In turn, the advertisement placeholder is transmitted to the publisher to render advertisements provided by the advertisement server system.

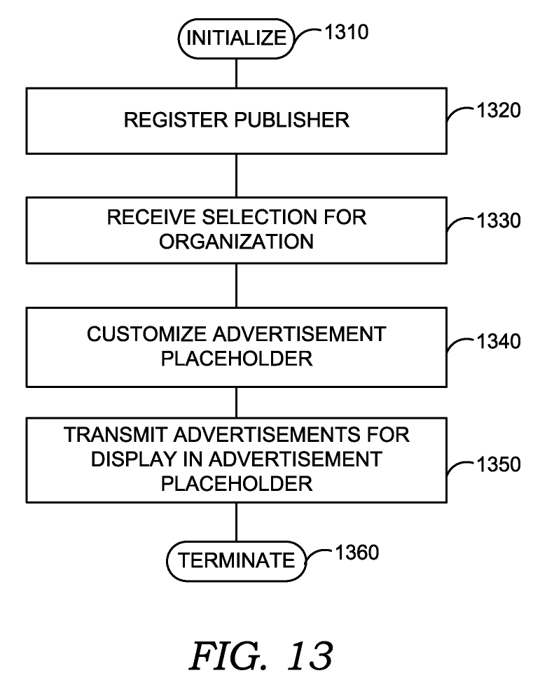

FIG. 13 is a logic diagram that illustrates an exemplary computer-implemented method for transmitting advertisements to registered publishers in accordance with embodiments of the invention. The advertisement server system initializes in step 1310. In step 1320, the advertisement server system registers a publisher. The advertisement server system receives, in step 1330, a selection of a philanthropic organization that receives a portion of the revenue earned by the publisher via an account management graphical user interface generated by the advertisement server system. In step 1340, the advertisement server system configures an advertisement placeholder that is displayed on a web page associated with the publisher. In some embodiments, the publisher is associated with internal or external sites that display the advertisement placeholder. In turn, one or more advertisements are transmitted from the advertisement server system to the publisher for display in the advertisement placeholder in step 1350. The advertisement content for the advertisement placeholder may be filtered differently for external sites and internal sites. In one embodiment, the advertisement server system tracks clicks on the advertisement placeholder or advertisement in the advertisement placeholder. And the revenue generated by the advertisement or advertisement placeholder is based on the number of clicks. Some portion of the revenue is moved to an account for the philanthropic organization. The method terminates in step 1360.

In some embodiments, the advertisement server system allows a publisher to create accounts that are associated with qualifying philanthropic organizations. In turn, revenue generated by an advertisement placeholder is accumulated in the account and distributed on a regular basis to the philanthropic organization. The advertisement server system allows the publisher to receive detailed reports on the distributed revenue. The advertisement server system allows the publisher to control the ratio of the revenue provided to the philanthropic organization.

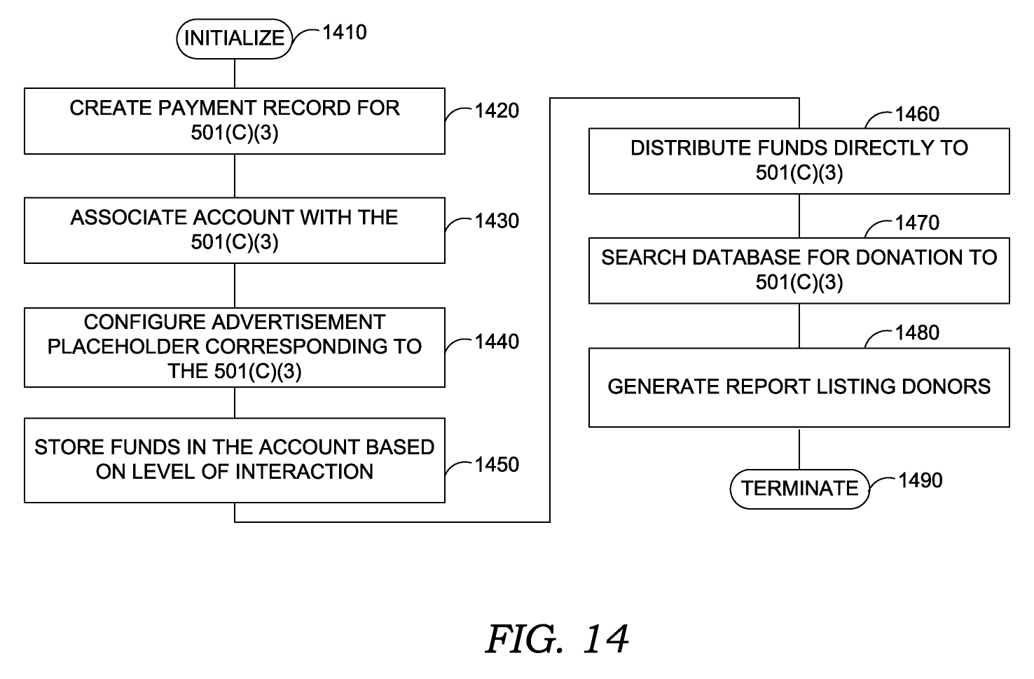

FIG. 14 is a logic diagram that illustrates an exemplary computer-implemented method for generating donation reports for registered publishers in accordance with embodiments of the invention. The advertisement server system initializes in step 1410. In step 1420, the advertisement server system creates a payment record for a philanthropic organization selected by the publisher. In step 1430, the payment records are linked to the philanthropic organization. At least one account dedicated for funds that are directly delivered to a philanthropic organization is associated with the publisher. The publisher may have other accounts that are not directed to philanthropic organizations. In step 1440, an advertisement placeholder is configured-for the at least one account dedicated to a philanthropic organization-to include a color, size, font, orientation, and placement selected by the publisher. In some embodiments, the advertisement placeholder displays advertisements and data about the philanthropic organization corresponding to the advertisement placeholder. In step 1450, the advertisement server system stores funds in the account dedicated to the philanthropic organization based on a level of interaction with the advertisement placeholder. In step 1460, the advertisement server system distributes the funds accumulated in the account to philanthropic organizations. In some embodiments, the advertisement server system identifies each publisher that sets up an account dedicated for the philanthropic organization and distributes funds to the philanthropic organization via the advertising server system as a donor. In step 1470, a database of accounts having donations for a publisher is searched by the advertisement server system in response to a request for the donations made by the publisher. In step 1480, a report that lists the donations for the publisher in response to the request is generated by the advertisement server system. The method terminates in step 1490.

In summary, the advertisement server system allows a publisher to direct revenue to a philanthropic organization. The advertisement server system allows the publisher to fully control revenue generated by advertisement placeholders rendered on a web page owned by the publisher. Some portion of the revenue may be distributed to qualified philanthropic organizations. These funds may be recognized as earnings or donations. And the funds may qualify for matching funds as part of a corporate giving campaign. The advertisement server may allow a publisher to register internal or corporate network webs pages to receive an advertisement placeholder and the advertisements for the advertisement placeholder.

The advertisement server system allows advertisers to create the advertisements that are rendered in the advertisement placeholder. The advertisement server system may increase the number of web pages that are available for monetization by an advertiser because very large profit-based entities and non-profit based entities have internal and external web pages that are not monetized with advertisements. These entities may allow the advertisement placeholder to be placed on their web page because any revenue generated by the advertisement placeholder supports a philanthropic organization. The advertiser may be able to monetize support pages, Intranets, forums, blogs, and the like that we previously unmonetized.

The advertisement server system allows the philanthropic organizations to benefit by receiving potential revenue streams and increasing visibility of the philanthropic organizations. The advertisement server system allows a large distributed group of publishers to provide year round charitable donations to the philanthropic organizations.

The foregoing descriptions of the embodiments of the invention are illustrative, and modifications in configuration and implementation are within the scope of the current description. For instance, while the embodiments of the invention are generally described with relation to FIGS. 1-14, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

We claim:

1. One or more computer-readable media storing computer-useable instructions that cause one or more processors to perform a method to manage a philanthropic advertising campaign, the method comprising:
registering a publisher with an advertisement server;
selecting an organization that receives a portion of the revenue earned by the publisher in an account management graphical user interface corresponding to advertisement server;
configuring an advertisement placeholder that is displayed on a website associated with the publisher;
sending the one or more advertisements to the publisher for display in the advertisement placeholder.

2. The media of claim 1, further comprising tracking clicks on the placeholder or advertisement in the placeholder.

3. The media of claim 1, wherein the revenue generated is based on the number of clicks.

4. The media of claim 1, wherein the organization is a philanthropic organization.

5. The media of claim 1, further comprising moving funds to an account for the philanthropic organization.

6. The media of claim 1, wherein the publisher is associated with internal or external sites that display the advertisement placeholder.

7. The media of claim 6, wherein content for the advertisement placeholder is filtered differently for external sites and internal sites.

8. A computer-implemented method to direct philanthropic funds via an advertisement campaign managed by one or more communicatively connected advertising server devices, the method comprising:
creating a payment record for a philanthropic organization selected by a publisher during registration with the advertising server devices;
associating at least one account dedicated for funds that are directly delivered to a philanthropic organization with the publisher;
configuring advertisement placeholders for the at least one account dedicated to a philanthropic organization to include a color, size, font, orientation, and placement selected by the publisher; and
storing funds in the account dedicated to the philanthropic organization based on a level of interaction with the advertisement placeholder.

9. The method of claim 8, wherein the publisher has other accounts that are not directed to philanthropic organizations.

10. The method of claim 9, wherein the publisher has at least two accounts.

11. The method of claim 8, wherein the advertisement placeholder displays advertisements and data about the philanthropic organization corresponding to the advertisement placeholder.

12. The method of claim 8, further comprising distributing the funds accumulated in the account to philanthropic organizations.

13. The method of claim 8, further comprising identifying each publisher that sets up an account dedicated to the philanthropic organization as a donor.

14. The method of claim 8, further comprising searching a database of accounts having donations for a publisher in response to a request for the donations made by the publisher.

15. The method of claim 14, further comprising generating a report for display that lists the donations for the publisher in the request.

16. An advertisement server system, the advertisement server system comprising:
one or more advertisement servers configured to register a publisher;
one or more databases connected to said advertisement server configured to store a record of a philanthropic organization selected by the publisher; and
said advertising server configured to present a management graphical user interface for customizing an advertisement placeholder for the publisher and the selected philanthropic organization.

17. The advertisement server system of claim 16, further comprising one or more client devices to render the advertisement placeholder and to receive advertisements that satisfy the publisher selected advertisement filtering criteria.

18. The advertisement server system of claim 17, wherein at least one client is an advertisement-funded client.

19. The advertisement server system of claim 16, wherein the database stores a portion of the revenue earned by the publisher in an account that corresponds to the philanthropic organization.

20. The advertisement server system of claim 14, wherein the one or more advertisement servers transmit one or more advertisements to the publisher for display in the advertisement placeholder.
